(19) United States
(12) Patent Application Publication
(10) Pub. No.: US 2013/0036672 A1
(43) Pub. Date: Feb. 14, 2013

(54) SLIDING DOOR PET ENTRY SYSTEM

(71) Applicant: KURT WESTERFIELD, VANCOUVER, WA (US)

(72) Inventor: KURT WESTERFIELD, VANCOUVER, WA (US)

(21) Appl. No.: 13/584,062

(22) Filed: Aug. 13, 2012

Related U.S. Application Data
(60) Provisional application No. 61/522,636, filed on Aug. 11, 2011.

(51) Int. Cl. E06B 7/32; E05F 15/20; B23P 11/00; E06B 3/46

(52) U.S. Cl. 49/62; 49/506

(57) ABSTRACT

A sliding door pet entry system, including a fixed door portion, having an interior side and an exterior side, and having and pet door built into it. The pet door may be automated with an electrical power cord which plugs into a wall outlet. The pet door is shaped and configured such that a sliding door portion which slides completely over the fixed door portion and the pet door without interference from the pet door. The sliding door pet entry system can further include a screen door roll attached to said fixed door portion which rolls out from said fixed door portion to cover the space opened by the sliding of the sliding door portion.

### CROSS-REFERENCE TO RELATED APPLICATION

This application is a continuation of and claims priority to co-pending provisional Application Ser. No. 61/522,636, filed 11 Aug. 2011, hereby incorporated herein by reference.

### FIELD OF THE INVENTION

The present invention relates to sliding doors and pet entry systems. More particularly, the present invention relates to automatic pet entry systems built into sliding doors.

### BACKGROUND

Many people have pets in their homes, and want to allow the pets to go outside when the pet so desires. To this end, pet entry systems have been created, which allow a pet to leave the house at will. There are numerous pet entry systems, from simple flaps built into holes in doors, to computerized automatic, or magnetic identification, pet entry systems that raise pet hatches or doors automatically when a pet comes near, or which only open for certain pets having some form of customized pet identification, whether on a collar, tag, or implanted in a pet. There are many ways in which these pet entry systems are installed, from cutting holes in doors, cutting holes in walls, and retrofitting doors and sliding doors.

Most homes have sliding doors, and these typically exit to some form of back yard or patio. It is very common for pet owners to wish to build a pet entry system into a sliding door to exit into their backyard.

Sliding doors can come in numerous systems. One common system has a fixed glass panel which does not slide, and a second sliding glass panel which slides either in front of or behind the fixed glass panel. Typically, the sliding panel slides on a track. These glass panels can be made of numerous types of glass or glass substitute substances, such as Lexan®, or dual panel and insulated glass panels. Screen doors are often built into the sliding door systems.

A well-known sliding glass system includes two insulated dual glass panels, the first of which is a fixed glass panel, and the second of which has a sliding glass panel that slides on a track on the exterior side of the fixed glass panel portion.

Building a pet entry system into a sliding door has numerous problems. Typically, the pet entry systems are built into the sliding glass panel portion of the system, which can interfere with the screen door system, and/or run into the non-sliding portion. Also, building the pet entry system into the sliding glass panel portion limits the type of pet entry system to one which is either entirely battery operated, or which is entirely mechanical, because a plug system is unwieldy and may not work on a pet entry system built into the sliding glass panel portion.

### SUMMARY

A sliding door pet entry system, including a fixed door portion, having an interior side and an exterior side, and having and pet door built into it. The pet door may be automated with an electrical power cord which plugs into a wall outlet. The pet door is shaped and configured such that a sliding door portion which slides completely over the fixed door portion and the pet door without interference from the pet door. The sliding door pet entry system can further include a screen door roll attached to said fixed door portion which rolls out from said fixed door portion to cover the space opened by the sliding of the sliding door portion. In the preferred embodiment, the sliding door portion and the fixed door portion both comprise glass panels. In other embodiments the fixed and sliding portions comprise panels of other materials such as wood or metal. The sliding door pet entry system can further include a screen door roll attached to said fixed door portion which rolls out from said fixed door portion to cover the space opened by the sliding of the sliding door portion.

The sliding door pet entry system presents numerous advantages, including: (1) can use existing sliding door systems with existing pet entry systems, a custom cut glass panel, and an exterior mount; (2) allows the sliding door to slide completely over and unimpeded by the pet entry system; (3) removes unsightly multiple panes and pane bars in existing sliding door implemented pet entry systems; (4) can be used in conjunction with and not interfering with screen doors as part of the sliding door system; (5) allows an automated pet entry system which can be plugged into an electrical wall mount and thus is not limited to battery operated systems or mechanical systems.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The present invention will be described by way of exemplary embodiments, but not limitations, illustrated in the accompanying drawings in which like references denote similar elements, and in which:

The accompanying drawings, which are incorporated into and constitute a part of this specification, illustrate one or more embodiments of the a sliding door pet entry system and, together with the detailed description, serve to explain the principles and implementations of the invention.

FIG. 1 shows a portion of a sliding door pet entry system from the outside with a pet exiting.

FIG. 2 shows a portion of a sliding door pet entry system from the inside.

FIG. 3 shows a portion of a sliding door pet entry system from the outside showing the track upon which the sliding door portion slides and showing that the sliding door portion slides in front of the exterior of the fixed door portion and in front of the pet entry door.

FIG. 4 shows an exterior mount of a sliding door pet entry system prior to mounting on the fixed door portion and the pet entry door.

FIG. 5 shows a portion of a sliding door pet entry system showing the exterior of the fixed door portion prior to the pet entry door mount and prior to the mounting of the exterior mount.

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

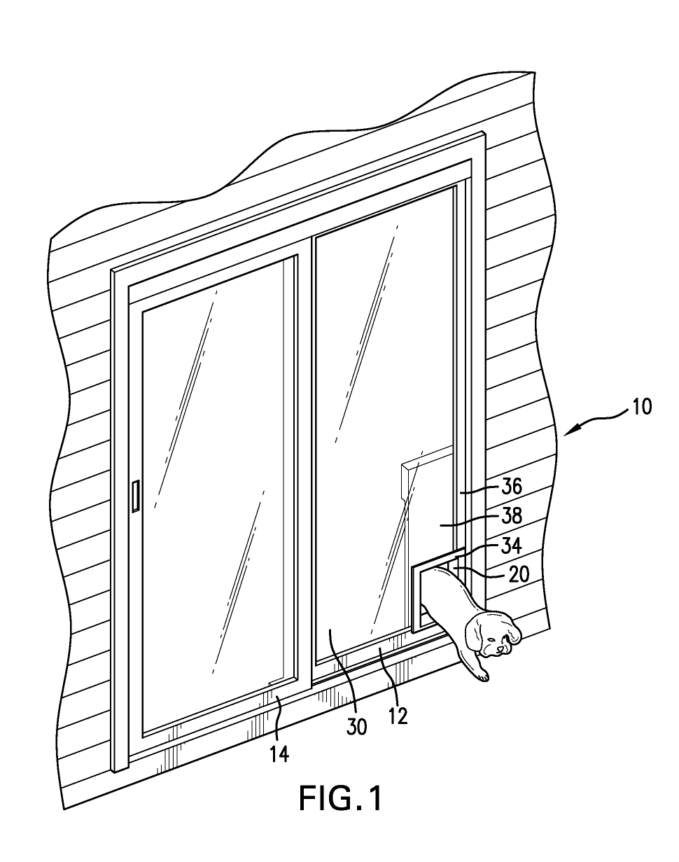

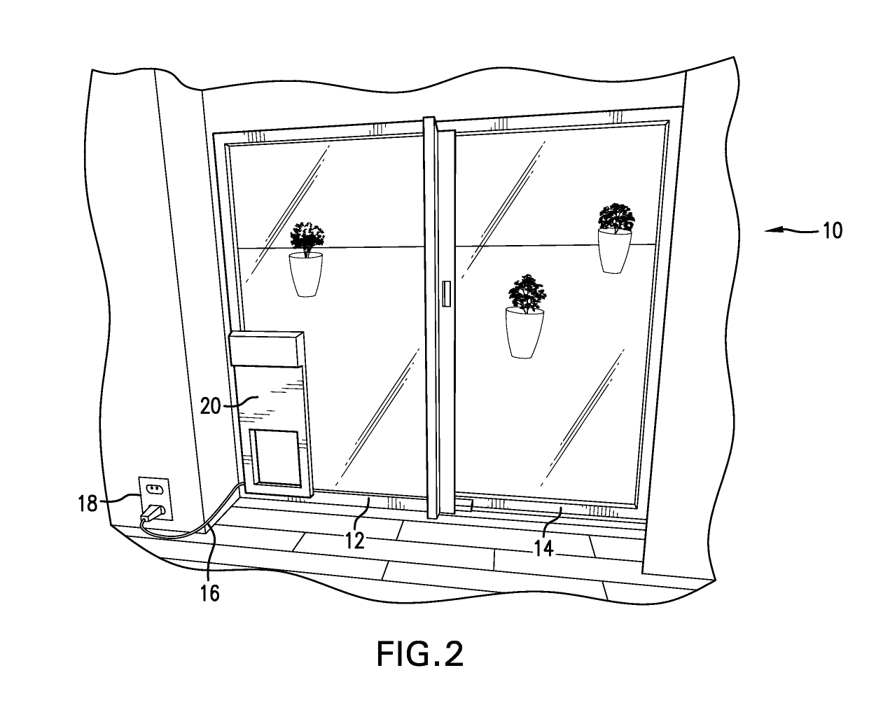

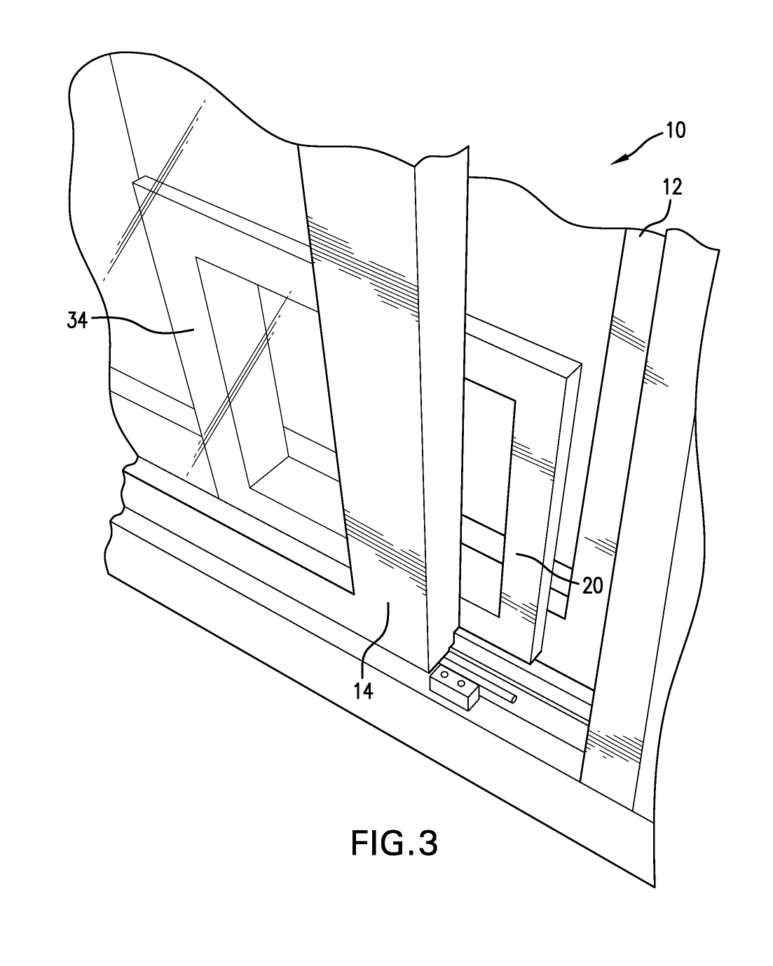

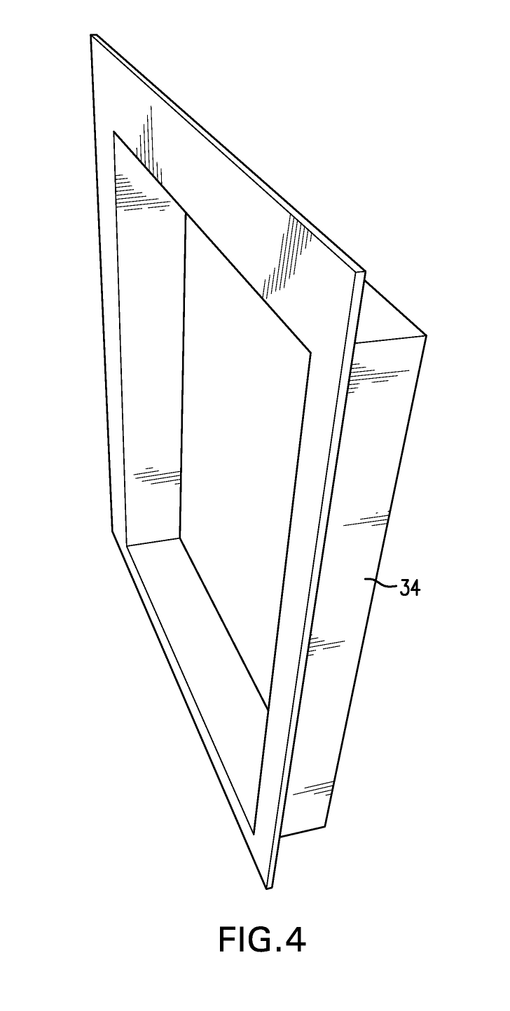

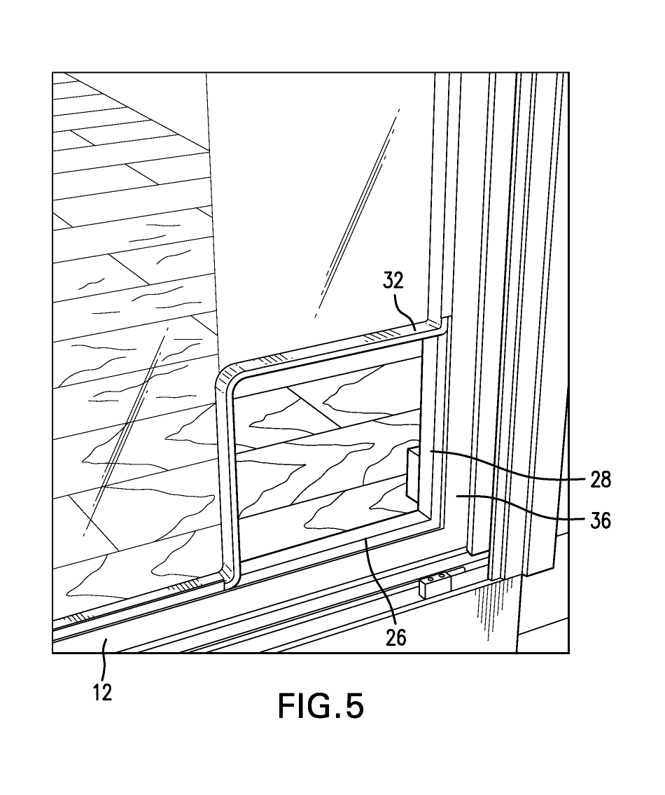

FIGS. 1-5 show a sliding door pet entry system 10. The sliding door pet entry system 10 has two door portions, a fixed door portion 12 and sliding door portion 14. Each door portion has an interior side, facing into the dwelling, and exterior side facing out of the dwelling. The sliding door portion 14 slides on a track 24 on the ground. The sliding door portion 14 slides completely in front of the fixed door portion 12 on the exterior side of the fixed door portion 12. In the preferred embodiment, the sliding door portion 14 and the fixed door portion 12 both comprise glass panels. In other embodiments, the fixed door portion 12 and sliding door portion 14 comprise panels of other materials such as wood or metal.

The fixed door portion 12 comprises a fixed door frame 36, a custom panel 30. The custom panel 30 has a cut out to accommodate a pet door 20. Preferably, the cut out is in a lower corner of said custom panel 30. The fixed door portion 12 has an exterior mount 32 that borders the cut out. The exterior mount 32 contacts and seals the custom panel 30. The pet door 20 is deposed in the cut out.

The pet door has a pet door inner frame 38 and an pet door outer frame 34. In the preferred embodiment, the pet door 20 is attached to the custom panel 30 with adhesive. The pet door inner frame 38 is attached with an adhesive, such as a two-sided tape to the interior side of the custom panel 30. The pet door outer frame 34 is attached with an adhesive to the exterior side of the custom panel 3 and to the pet door inner frame 38.

In other embodiments, the pet door 20 is attached to a bottom frame mount 26 and a side frame mount 28 in the sliding door portion 12 and to the exterior mount 32. The pet door inner frame 38 and pet door outer frame are mated in the cut out portion of the custom panel 30, then screwed to the bottom frame mount 26, the side frame mount 28 and the exterior mount 32.

The pet door 20 is mounted and configured such that the exterior side of the pet door 20 is substantially flush with said fixed door portion 12. As such, the sliding door portion 14 can slide unimpeded completely over and in front of the exterior side of said fixed door portion 12 and completely in front of the exterior side of the pet door 20. In the preferred embodiment, the pet door 20 is an automatic, electrically operated pet door, such as the Power Pet Fully Automatic Pet Door by High Tech Pet Products, Inc. Such a door detects an ultrasonic signal transmitted by a special pet collar to detect the approach of a pet and open the door. However, other automatic pet door designs may be used. In other embodiments, the pet door 20 is not automated and relies on a pet or human to operate it. The automatic version of the pet door 20 has an electrical power cord and a plug 16 that can be plugged into a wall outlet 18 for power.

In the preferred embodiment, the pet door 20 is vertically sliding door. In other embodiments, the pet door 20 may be some other type of door such as a swinging door.

In the preferred embodiment, an existing sliding door system is modified and a custom panel 30 made for the fixed door portion 12. The existing sliding door system has the sliding door portion 14 sliding on a track 24 on the exterior side of the fixed door portion 12. The custom panel 30 is created by cutting the existing panel in the fixed door portion 12 to fit the exterior mount 32.

In the preferred embodiment, an existing sliding door system is modified to create the sliding door pet entry system 10. The panel of the fixed door portion is removed from a mounting border strip in the fixed door frame 36 that normally holds the panel in place. In a corner of the fixed door frame 36, a portion of the mounting frame is pulled out and bent to from the exterior mount 32. In other embodiments, the exterior mount 32 is separately fabricated and installed. The custom panel 30 is created by cutting the existing panel in the fixed door portion 12 to fit the exterior mount 32.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

1. A sliding door pet entry system, comprising
a fixed door portion, having an interior side and an exterior side;
a sliding door portion configured to slide over the fixed door portion; and
a pet door built into the fixed door portion, configured so that the sliding door portion will slide over the pet door without interference from the pet door.

2. The sliding door pet entry system of claim 1, further comprising a screen door roll attached to said fixed door portion configured to roll out from said fixed door portion to cover a space opened when the sliding door portion is opened.

3. The sliding door pet entry system of claim 1, wherein the pet door is an electrically operated automatic pet door.

4. The sliding door pet entry system of claim 3, wherein the pet door has a vertically sliding door panel.

5. The sliding door pet entry system of claim 3, wherein electrically operated automatic pet door has an electrical plug configured to plug into a wall outlet.

6. The sliding door pet entry system of claim 1, wherein the sliding door portion is configured to slide in front the exterior side of the fixed door portion.

7. The sliding door pet entry system of claim 1, wherein the sliding door portion is configured to slide in back the interior side of the fixed door portion.

8. The sliding door pet entry system of claim 1, wherein the sliding door portion comprises a glass panel.

9. The sliding door pet entry system of claim 1, wherein the fixed door portion comprises a glass panel.

10. A method for installing a pet door entry system in sliding door comprising:
cutting a portion out of a panel in a fixed door portion of the sliding door, thereby forming a cut out in the panel; and
installing a pet door in the cut out in the panel of the fixed door portion such that a sliding door portion can slide over the fixed door portion and over the pet door without interference from the pet door.

11. A method of claim 10 further comprising:
pulling a portion of a mounting frame away from a corner of a fixed door frame in the fixed door portion, a portion of the mounting frame is pulled out and bent to from an exterior mount, the exterior mount configured to contact, support and seal the panel.
